(19) United States
(12) Patent Application Publication
(10) Pub. No.: US 2025/0243332 A1
(43) Pub. Date: Jul. 31, 2025

(54) A BREATHABLE, BIAXIALLY-ORIENTED POLYETHYLENE FILM

(71) Applicant: Dow Global Technologies LLC, Midland, MI (US)

(72) Inventors: Guihong Liao, Shanghai (CN); Jianping Pan, Shanghai (CN); Xiaobing Yun, Shanghai (CN); Haiyang Yu, Shanghai (CN); Rongjuan Cong, Freeport, TX (US)

(21) Appl. No.: 18/855,581

(22) PCT Filed: May 7, 2022
(86) PCT No.: PCT/CN2022/091431

§ 371 Date: Oct. 9, 2024

(51) Int. Cl. C08J 5/18; B29C 48/00; B29C 48/08; B29C 55/14; B29K 23/00; B29K 105/16; C08K 3/26; C08L 23/0807

(52) U.S. Cl. CPC C08J 5/18; B29C 48/0018; B29C 48/022; B29C 48/08; B29C 55/14; C08K 3/26; C08L 23/0815; B29K 2023/08; B29K 2105/16; B29K 2995/0053; B29K 2995/0065; C08J 2323/08; C08K 2003/265; C08L 2203/16

(57) ABSTRACT

A biaxially-oriented polyethylene film comprising 25 to 60 wt. % of an ethylene-alpha-olefin copolymer including an ethylene monomer and a 1-octene or 1-hexene comonomer along with an amount of copolymer eluting in an elution profile via iCCD between 65.0° C. and 95.0° C. of at least 50% and a molecular weight in the elution profile between 65.0° C. and 95.0° C. greater than 90,000 g/mol: and from 40 to 75 wt. % of a filler is disclosed. The biaxially-oriented film has a water vapor transmission rate of greater than 300 g/m²/day at 40.0° and at a relative humidity of 60%, and an elongation at break of less than 200% in both the machine direction and the transverse direction. An article comprising this biaxially-oriented polyethylene film is also disclosed.

### TECHNICAL FIELD

The present disclosure generally relates to biaxially-oriented polyethylene films, and articles containing the biaxially-oriented polyethylene films.

### INTRODUCTION

Breathable films are used in a wide variety of applications, including fresh produce packaging, baby diapers, adult incontinence products, surgical gowns, and other hygiene and medical applications. Breathable films have microporous morphology (i.e., micro-voids) to provide a water vapor transmission rate (“WVTR”) that assists in allowing the passage of moisture vapor and eliminating water droplet condensation. Breathability or WVTR is an important property of many breathable films because films can act as a liquid barrier while permitting the transmission of water vapor to provide benefits such as protection or comfort. For example, breathable films used for plastic food packaging of fruits can assist in preventing water droplet condensation on fruits which leads to growth of fungus.

Breathable films are typically made by incorporating filler (e.g., CaCO₃) into polyolefin resins, such as polyethylene or polypropylene, making a cast or blown film, and stretching or orienting the cast or blown film via machine direction orientation rolls via tentering, or via intermeshing gears whereby the film is ringrolled or incrementally stretched in one or both the machine direction or transverse direction below the melting point of the polyolefin resins. Micro-voids are created, in part, because of the addition of the filler into polyolefins of the film. The post extrusion process, such as machine direction orientation or use of inter-digitating, also contributes to creating micro-voids in the film by creating cavitation around the filler particles at the filler and polyolefin interface. The machine direction tensile strength of currently produced films is acceptable, but transverse or cross direction tensile strength can be weak. This is a major obstacle in down gauging the film. Using less plastic, down gauged films create less environmental impact. As such, a need for films with improved transverse direction tensile strength and desirable properties such as water vapor transmission rate, hydrohead, and machine direction tensile strength exists.

A relatively new material technology on the processing side of breathable films is biaxially-oriented polyethylene (BOPE) films. Such BOPE films are formed by cast extrusion, and are then oriented in the machine direction (MD) followed by orientation in the transverse direction (TD) in a tenter frame. Alternatively this process can also be performed simultaneously.

### SUMMARY OF DISCLOSURE

The present disclosure meets the forgoing needs by providing biaxially-oriented films with desired and/or improved properties, including, for example, transverse direction tensile strength, machine direction tensile strength, water vapor transmission rate, and hydrohead. In aspects, when compared to existing film structures, the inventive biaxially-oriented films of the present disclosure can exhibit such improved and/or desired properties, while also being capable of being down gauged during processing.

Disclosed herein is a biaxially-oriented film. The biaxially-oriented film comprises: a. from 25 to 60 wt. % of an ethylene-alpha-olefin copolymer comprising i) an ethylene monomer and 1-octene or 1-hexene comonomer, ii) an amount of copolymer eluting in an elution profile via improved comonomer composition distribution (iCCD) analysis method between 65.0° C. and 95.0° C. of at least 50 wt. %, and iii) a molecular weight (Mw) in the elution profile via improved comonomer composition distribution (iCCD) analysis method between 65.0° C. and 95.0° C. of greater than 90,000 g/mol; and b. from 40 to 75 wt. % of a filler; and wherein the film has a water vapor transmission rate of greater than 300 g/m²/day at 40° C. and at a relative humidity of 60%, and an elongation at break of less than 200% in both the machine direction and the transverse direction.

Also disclosed herein are articles. An article can comprise the biaxially-oriented polyethylene film according to embodiments disclosed herein.

The disclosure is described in more detail in the Detailed Description.

### BRIEF DESCRIPTION OF THE DRAWINGS

FIG. 1 schematically depicts an elution profile via iCCD of certain example polymers.

FIG. 2 is the graph of octene mole % versus elution temperature of iCCD at R² of 0.978.

### DETAILED DESCRIPTION

Breathable films can have a wide variety of applications, including, for example, fresh produce packaging, baby diapers, adult incontinence products, surgical gowns, and other hygiene and medical applications. The disclosure may, however, be embodied in different forms and should not be construed as limited to the examples set forth in this disclosure. Rather, these examples are provided so that this disclosure will be thorough and complete, and will fully convey the scope of the subject matter to those skilled in the art.

As used herein, the term “polymer” means a polymeric compound prepared by polymerizing monomers, whether of the same or a different type. The generic term polymer thus embraces the term homopolymer (employed to refer to polymers prepared from only one type of monomer), and the term copolymer or interpolymer. Trace amounts of impurities (for example, catalyst residues) may be incorporated into and/or within the polymer. A polymer may be a single polymer, a polymer blend, or a polymer mixture, including mixtures of polymers that are formed in situ during polymerization.

As used herein, the term “polyolefin” means a polymer that comprises, in polymerized form, a majority amount of olefin monomer, for example ethylene or propylene (based on the weight of the polymer), and optionally may comprise one or more comonomers.

As used herein, the term “polyethylene” means a polymer comprising a majority amount (>50 mol %) of units which have been derived from ethylene monomer.

As used herein, the term “copolymer” means any polymer having two or more monomers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The biaxially-oriented polyethylene film can comprise from 25 to 60 weight percent (wt. %) of an ethylene-alpha-olefin copolymer and from 40 to 75 wt. % of a filler, based on total weight of the biaxially-oriented polyethylene film. All individual values and subranges of 25 to 60 wt. % are disclosed and incorporated herein. For example, the biaxially-oriented polyethylene film can comprise from 25 to 55 wt. %, from 28 to 32 wt. %, from 30 to 50 wt. %, from 38 to 42 wt. %, 35 to 55 wt. %, from 40 to 50 wt. %, or from 30 to 40 wt. % and from 48 to 52 wt. % of an ethylene-alpha-olefin copolymer, based on the total weight of the biaxially-oriented polyethylene film. All individual values of from 40 to 75 wt. % of a filler are also disclosed and incorporated herein. For example, the biaxially-oriented polyethylene film can comprise from 40 to 75 wt. %, from 45 to 70 wt. %, from 45 to 75 wt. %, from 68 to 72 wt. %, from 58 to 62 wt. %, from 48 to 52 wt. % 50 to 70 wt %, from 50 to 60 wt % or from 60 to 70 wt. % of a filler, based on the total weight of the biaxially-oriented polyethylene film.

### Ethylene-Alpha-Olefin Copolymer of the Biaxially-Oriented Polyethylene Film

The biaxially-oriented polyethylene film disclosed herein comprises an ethylene-alpha-olefin copolymer. The ethylene-alpha-olefin copolymer comprises an ethylene monomer and 1-octene or 1-hexene comonomer. The ethylene-alpha-olefin copolymer can be an ethylene/1-octene copolymer. The ethylene-alpha-olefin copolymer can be an ethylene/1-hexene copolymer.

The ethylene-alpha-copolymer can comprise from 60 to 95 wt. % ethylene monomer and from 5 to 45 wt. % of 1-octene or 1-hexene comonomer, based on the total weight of the ethylene-alpha-olefin copolymer. All individual values and subranges are disclosed and incorporated. For example, the ethylene-alpha-copolymer can comprise from 80 to 97 wt. % ethylene monomer and from 3 to 20 wt. % of 1-octene or 1-hexene comonomer, based on the total weight of the ethylene-alpha-olefin copolymer. The ethylene-alpha-copolymer can comprise from 85 to 96% wt.% ethylene monomer and from 4 to 15 wt. % of 1-octene or 1-hexene comonomer. The ethylene-alpha-copolymer can comprise from 88 to 98% wt.% ethylene monomer and from 2 to 12 wt. % of 1-octene or 1-hexene comonomer. The ethylene-alpha-copolymer can comprise from 86 to 90 wt. % ethylene monomer and from 14 to 10 wt. % of 1-octene or 1-hexene comonomer. The ethylene-alpha-copolymer can comprise from 90 to 94% wt.% ethylene monomer and from 6 to 10 wt. % of 1-octene or 1-hexene comonomer. The ethylene-alpha-copolymer can comprise from 91 to 95 wt. % ethylene monomer and from 5 to 9 wt. % of 1-octene or 1-hexene comonomer. The ethylene-alpha-copolymer can comprise from 93 to 97% wt.% ethylene monomer and from 3 to 7 wt. % of 1-octene or 1-hexene comonomer.

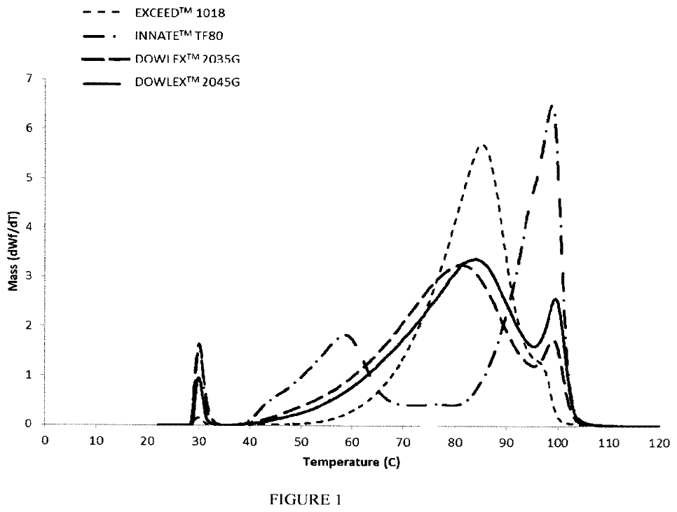

The ethylene-alpha-olefin copolymer comprises an amount of copolymer eluting in an elution profile via improved comonomer composition distribution (iCCD) analysis method between 65.0° C. and 95.0° C. of at least 50 wt. %, based on total area of the ethylene-alpha-olefin copolymer eluted during iCCD analysis. The amount or weight percent of copolymer eluting in an elution profile via iCCD analysis method between 65.0° C. and 95.0° C. is calculated based on the test method described below. An elution profile via iCCD can be seen in FIG. 1. The weight fraction of material eluting between 65.0° C. and 95.0° C. can be calculated directly. It is clear that the inventive examples had high wt % material with significant Mw eluting between 65.0° C. and 95.0° C. (see Table 4). All individual values and subranges of at least 50 wt. % are disclosed and incorporated herein. For example, the ethylene-alpha-olefin copolymer can comprise an amount of copolymer eluting in an elution profile via improved comonomer composition distribution (iCCD) analysis method between 65.0° C. and 95.0° C. of at least 55 wt. %, of at least 60 wt. %, of at least 70 wt. %, at least 80 wt. % or at least 90 wt. % based on total area of the ethylene-alpha-olefin copolymer eluted during iCCD analysis. The ethylene-alpha olefin copolymer can comprise an amount of copolymer eluting in an elution profile via improved comonomer composition distribution (iCCD) analysis method between 65.0° C. and 95.0° C. between 50-95 wt. % based on total area of the ethylene-alpha-olefin copolymer eluted during iCCD analysis. All individual values and subranges between 50-90 wt. % are disclosed and included. For example, the ethylene-alpha olefin copolymer can comprise an amount of copolymer eluting in an elution profile via improved comonomer composition distribution (iCCD) analysis method between 65.0° C. and 95.0° C. between 60-85 wt. %, 70-80 wt. %, 70-74 wt. % 73-77 wt. %, 80-84 wt. %, or 88 to 92 wt. % based on total area of the ethylene-alpha-olefin copolymer eluted during iCCD analysis.

The ethylene-alpha-olefin copolymer may be quantified by its temperature range in an elution profile via improved comonomers composition distribution (iCCD) analysis method. Unless specified, any elution profile referred to herein is the elution profile observed via iCCD. The ethylene-alpha-olefin copolymer may be “multimodal,” meaning that they include at least two peaks in their elution profile. Some copolymers may be “bimodal,” meaning that two major peaks are present. The ethylene-alpha-olefin copolymer may have a single peak between 65.0-95.0° C. The copolymer eluting in the elution profile between 65.0-95.0° C. may comprise at least 50% by weight of the ethylene-alpha-olefin copolymer based on total area of the ethylene-alpha-olefin copolymer eluted during iCCD analysis. The copolymer eluting in the elution profile between 65.0-95.0° C. may comprise at least 60% by weight of the ethylene-alpha-olefin copolymer based on total area of the ethylene-alpha-olefin copolymer eluted during iCCD analysis. The copolymer eluting in the elution profile between 65.0-95.0° C. may comprise at least 70% by weight of the ethylene-alpha-olefin copolymer based on total area of the ethylene-alpha-olefin copolymer eluted during iCCD analysis. The copolymer eluting in the elution profile between 65.0-95.0° C. may comprise at least 80% by weight of the ethylene-alpha-olefin copolymer based on total area of the ethylene-alpha-olefin copolymer eluted during iCCD analysis. The copolymer eluting in the elution profile between 65.0-95.0° C. may comprise no more than 99% by weight of the ethylene-alpha-olefin copolymer based on total area of the ethylene-alpha-olefin copolymer eluted during iCCD analysis.

The ethylene-alpha-olefin copolymer can comprise a molecular weight (Mw) in an elution profile via improved comonomer composition distribution (iCCD) analysis method between 65.0° C. and 95.0° C. of greater than 90,000 g/mol. The molecular weight (Mw) of the copolymer eluting between 65.0° C. and 95.0° C. in the iCCD elution profile is calculated using the test method described below. All individual values and subranges of greater than 90,000 g/mol are disclosed and incorporated herein. For example, the ethylene-alpha-olefin copolymer can comprise a molecular weight (Mw) in an elution profile via improved comonomer composition distribution (iCCD) analysis method between 65.0° C. and 95.0° C. of greater than 95,000 g/mol or greater than 100,000 g/mol. For example, the ethylene-alpha-olefin copolymer can comprise a molecular weight (Mw) in an elution profile via improved comonomer composition distribution (iCCD) analysis method between 65.0° C. and 95.0° C. of less than 250,000 g/mol. The ethylene-alpha-olefin copolymer can comprise a molecular weight (Mw) in an elution profile via improved comonomer composition distribution (iCCD) analysis method between 65.0° C. and 95.0° C. from 90,000-250,000 g/mol. All individual values and subranges between 90,000 and 250,000 g/mol are included and disclosed. For example, the ethylene-alpha-olefin copolymer can comprise a molecular weight (Mw) in an elution profile via improved comonomer composition distribution (iCCD) analysis method between 65.0° C. and 95.0° C. from 95,000-200,000 g/mol; 100,000-150,000g/mol; or 102,000-120,000 g/mol.

The ethylene-alpha-olefin copolymer may have a density of from 0.910 g/cm3 to 0.940 g/cm3. All individual values and subranges are included herein. For example, the ethylene-alpha-olefin copolymer may have a density of from 0.912 to 0.935 g/cm3, from 0.914 to 0.930 g/cm³, from 0.916 to 0.930 g/cm3, 0.910 to 0.920 g/cm3, from 0.920 to 0.930 g/cm3, 0.916 to 0.920 g/cm³, 0.917 to 0.921 g/cm3, 0.918 to 0.922 g/cm3, 0.924 to 0.928 g/cm3, or from 0.925 to 0.929 g/cm3.

The ethylene-alpha-olefin copolymer may have a melt index (I₂) of less than 6.0 g/10 min, less than 5.0 g/10 min, less than 4.0 g/10 min, less than 3.0 g/10 min, or less than 2.0 g/10 min or less than 1.5 g/10 min based on ASTM D-1238. In embodiments, the ethylene-alpha-olefin copolymer has a melt index (I₂) of less than 6.0 g/10 min and greater than 0.5 g/10 min, where melt index (I₂) is measured in accordance with ASTM D 1238 at 190° C. and a 2.16 kg load. The ethylene-alpha-olefin copolymer may have a melt index (I₂) between 0.5 to 6.0 g/10 min. The ethylene-alpha-olefin copolymer may have a melt index (I₂) between 0.5 to 5.5 g/10 min. The ethylene-alpha-olefin copolymer may have a melt index (I₂) between 0.5 to 5.0 g/10 min. The ethylene-alpha-olefin copolymer may have a melt index (I₂) between 0.5 to 4.5 g/10 min. The ethylene-alpha-olefin copolymer may have a melt index (I₂) between 0.5 to 4.0 g/10 min. The ethylene-alpha-olefin copolymer may have a melt index (I₂) between 0.5 to 3.5 g/10 min. The ethylene-alpha-olefin copolymer may have a melt index (I₂) between 0.5 to 3.0 g/10 min. The ethylene-alpha-olefin copolymer may have a melt index (I₂) between 0.5 to 2.5 g/10 min. The ethylene-alpha-olefin copolymer may have a melt index (I₂) between 0.5 to 2.0 g/10 min. The ethylene-alpha-olefin copolymer may have a melt index (I₂) between 0.05 to 1.5 g/10 min. The ethylene-alpha-olefin copolymer may have a melt index (I₂) between 0.08 to 1.2 g/10 min. The ethylene-alpha-olefin copolymer may have a melt index (I₂) between 1.1 to 1.5 g/10 min. The ethylene-alpha-olefin copolymer may have a melt index (I₂) between 1.5 to 1.9 g/10 min.

Commercially available examples of ethylene-alpha-olefin copolymers suitable to be used in the current disclosure include but are not limited to copolymers from The Dow Chemical Company (Midland, MI) available under the tradename DOWLEX™, and ELITE™, such as DOWLEX™ 2045, as well as copolymers commercially available from Exxon Mobil under the name Exceed, such as Exceed 1018.

In addition to the ethylene-alpha-olefin copolymer, a biaxially-oriented polyethylene film according to embodiments disclosed herein may comprise one or more additional polymers such as propylene-based plastomers or elastomers, polyvinylidene chloride (PVDC), polyethylene terepthalate (PET), oriented polypropylene (OPP), polyacrylic imides, butyl acrylates, peroxides (such as peroxypolymers, e.g., peroxyolefins), silanes (e.g., epoxysilanes), reactive polystyrenes, chlorinated polyethylene, olefin block copolymers, propylene copolymers, ionomers, and graft-modified polymers (e.g., maleic anhydride grafted polyethylene). The one or more additional polymers may be present in an amount of less than or equal to 25 wt. %, 20 wt. %, 15 wt. %, 12 wt. %, 10 wt. %, 8 wt. %, 5 wt. %, 3 wt. %, 2 wt. %, 1 wt. %, or 0.5 wt. %, based on the total weight of the biaxially-oriented polyethylene film.

The biaxially-oriented polyethylene film may include additional components such as one or more additives. Such additives include, but are not limited to, antistatic agents, color enhancers, dyes, lubricants, opacifiers, nucleators, processing aids, pigments, primary anti-oxidants, secondary anti-oxidants, UV stabilizers, thermal stabilizers, biocides, antimicrobial agents, colorants, anti-stat additives, anti-blocks, slip agents, tackifiers, fire retardants, clarifiers/nucleators odor reducer agents, anti-fungal agents, and combinations thereof. The biaxially-oriented polyethylene film may contain from 0.1 to 10 percent by the combined weight of such additives, based on the total weight of the biaxially-oriented polyethylene film including such additives.

### Polymerization

Any conventional polymerization process may be employed to produce the ethylene-alpha-olefin copolymers described herein. Such conventional polymerization processes include, but are not limited to, slurry polymerization processes, solution polymerization process, gas phase polymerization process using one or more conventional reactors, e.g., loop reactors, isothermal reactors, stirred tank reactors, batch reactors in parallel, series, and/or any combinations thereof. The ethylene-alpha-olefin copolymer may, for example, be produced via solution phase polymerization process using one or more loop reactors, isothermal reactors, and combinations thereof.

In general, the solution phase polymerization process may occur in one or more well-mixed reactors such as one or more isothermal loop reactors or one or more adiabatic reactors at a temperature in the range of from 115.0 to 250.0° C. (e.g., from 115.0 to 210.0° C.), and at pressures in the range of from 300 to 1,000 psi (e.g., from 400 to 800 psi). In a dual reactor, the temperature in the first reactor is in the range of from 115.0 to 190.0° C. (e.g., from 160.0 to 180.0° C.), and the second reactor temperature is in the range of 150.0 to 250.0° C. (e.g., from 180.0 to 220.0° C.). In a single reactor, the temperature in the reactor is in the range of from 115.0 to 250.0° C. (e.g., from 115.0 to 225.0° C.).

The residence time in the solution phase polymerization process may be in the range of from 2 to 30 minutes (e.g., from 5 to 25 minutes). Ethylene, solvent, hydrogen, one or more catalyst systems, optionally one or more cocatalysts, and one or more comonomers are fed continuously to one or more reactors. Exemplary solvents include, but are not limited to, isoparaffins. For example, such solvents are commercially available under the name ISOPAR™ E from ExxonMobil Chemical Co., Houston, Texas. The resultant mixture of the polyethylene composition and solvent is then removed from the reactor and the polyethylene composition is isolated. Solvent is typically recovered via a solvent recovery unit, e.g., heat exchangers and vapor liquid separator drum, and is then recycled back into the polymerization system.

The ethylene-alpha-olefin copolymer may be produced via solution polymerization in a dual reactor system, for example a dual loop reactor system, wherein ethylene is polymerized in the presence of one or more catalyst systems. One or more cocatalysts may be present. The ethylene-alpha-olefin copolymer may be produced via solution polymerization in a single reactor system, for example a single loop reactor system, wherein ethylene is polymerized in the presence of two catalyst systems.

### Catalyst Systems

The term “independently selected” is used herein to indicate that the R groups, such as, R¹, R², R³, R⁴, and R⁵ can be identical or different (e.g., R¹, R², R³, R⁴, and R⁵ may all be substituted alkyls or R¹ and R² may be a substituted alkyl and R³ may be an aryl, etc.). Use of the singular includes use of the plural and vice versa (e.g., a hexane solvent, includes hexanes). A named R group will generally have the structure that is recognized in the art as corresponding to R groups having that name. These definitions are intended to supplement and illustrate, not preclude, the definitions known to those of skill in the art.

The term “procatalyst” refers to a compound that has catalytic activity when combined with an activator. The term “activator” refers to a compound that chemically reacts with a procatalyst in a manner that converts the procatalyst to a catalytically active catalyst. As used herein, the terms “co-catalyst” and “activator” are interchangeable terms.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₄₀)alkyl is an alkyl group having from 1 to 40 carbon atoms in its unsubstituted form. In some general structures, certain chemical groups may be substituted by one or more substituents such as R^{S}. An R^{S} substituted version of a chemical group defined using the “(Cₓ-C_{y})” parenthetical may contain more than y carbon atoms depending on the identity of any groups R^{S}. For example, a “(C₁-C₄₀)alkyl substituted with exactly one group R^{S}, where R^{S} is phenyl (—C₆H₅)” may contain from 7 to 46 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all the carbon atom-containing substituents R^{S}.

The term “substitution” means that at least one hydrogen atom (—H) bonded to a carbon atom or heteroatom of a corresponding unsubstituted compound or function group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent.

The term “—H” means a hydrogen or hydrogen radical that is covalently bonded to another atom. “Hydrogen” and “—H” are interchangeable, and unless clearly specified mean the same thing.

The term “(C₁-C₄₀)hydrocarbyl” means a hydrocarbon radical of from 1 to 40 carbon atoms and the term “(C₁-C₄₀)hydrocarbylene” means a hydrocarbon diradical of from 1 to 40 carbon atoms, in which each hydrocarbon radical and each hydrocarbon diradical is aromatic or non-aromatic, saturated or unsaturated, straight chain or branched chain, cyclic (including mono- and poly-cyclic, fused and non-fused polycyclic, including bicyclic; 3 carbon atoms or more) or acyclic and is unsubstituted or substituted by one or more R^{S}.

In this disclosure, a (C₁-C₄₀)hydrocarbyl can be an unsubstituted or substituted (C₁-C₄₀)alkyl, (C₃-C₄₀)cycloalkyl, (C₃-C₂₀)cycloalkyl-(C₁-C₂₀)alkylene, (C₆-C₄₀)aryl, or (C₆-C₂₀)aryl-(C₁-C₂₀)alkylene. In some systems, each of the aforementioned (C₁-C₄₀)hydrocarbyl groups has a maximum of 20 carbon atoms (i.e., (C₁-C₂₀)hydrocarbyl) and other systems, a maximum of 12 carbon atoms.

The terms “(C₁-C₄₀)alkyl” and “(C₁-C₁₈)alkyl” mean a saturated straight or branched hydrocarbon radical of from 1 to 40 carbon atoms or from 1 to 18 carbon atoms, respectively, that is unsubstituted or substituted by one or more R^{S}. Examples of unsubstituted (C₁-C₄₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₄₀)alkyl are substituted (C₁-C₂₀)alkyl, substituted (C₁-C₁₀)alkyl, trifluoromethyl, and [C₄₅] alkyl. The term “[C₄₅] alkyl” (with square brackets) means there is a maximum of 45 carbon atoms in the radical, including substituents, and is, for example, a (C₂₇-C₄₀)alkyl substituted by one R^{S}, which is a (C₁-C₅)alkyl, respectively. Each (C₁-C₅)alkyl may be methyl, trifluoromethyl, ethyl, 1-propyl, 1-methylethyl, or 1,1-dimethylethyl. The term “(C₆-C₄₀)aryl” means an unsubstituted or substituted (by one or more R^{S}) mono-, bi- or tricyclic aromatic hydrocarbon radical of from 6 to 40 carbon atoms, of which at least from 6 to 14 of the carbon atoms are aromatic ring carbon atoms, and the mono-, bi-or tricyclic radical comprises 1, 2, or 3 rings, respectively; wherein the 1 ring is aromatic and the 2 or 3 rings independently are fused or non-fused and at least one of the 2 or 3 rings is aromatic. Examples of unsubstituted (C₆-C₄₀)aryl are unsubstituted (C₆-C₂₀)aryl unsubstituted (C₆-C₁₈)aryl; 2-(C₁-C₅)alkyl-phenyl; 2,4-bis(C₁-C₅)alkyl-phenyl; phenyl; fluorenyl; tetrahydrofluorenyl; indacenyl; hexahydroindacenyl; indenyl; dihydroindenyl; naphthyl; tetrahydronaphthyl; and phenanthrene. Examples of substituted (C₆-C₄₀)aryl are substituted (C₁-C₂₀)aryl; substituted (C₆-C_{18)aryl;} 2,4-bis[(C₂₀)alkyl]-phenyl; polyfluorophenyl; pentafluorophenyl; and fluoren-9-one-1-yl.

The term “(C₃-C₄₀)cycloalkyl” means a saturated cyclic hydrocarbon radical of from 3 to 40 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀)cycloalkyl are unsubstituted (C₃-C₂₀)cycloalkyl, unsubstituted (C₃-C₁₀)cycloalkyl, cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, substituted (C₃-C₁₀)cycloalkyl, cyclopentanon-2-yl, and 1-fluorocyclohexyl.

The term “(C₁-C₄₀)alkylene” means a saturated straight chain or branched chain diradical (i.e., the radicals are not on ring atoms) of from 1 to 40 carbon atoms that is unsubstituted or substituted by one or more R^{S}. Examples of unsubstituted (C₁-C₅₀)alkylene are unsubstituted (C₁-C₂₀)alkylene, including unsubstituted —CH₂CH₂—, —(CH₂)₃—, —(CH₂)₄—, —(CH₂)₅—, —(CH₂)₆—, —(CH₂)₇—, —(CH₂)₈—, —CH₂C*HCH₃, and —(CH₂)₄C*(H)(CH₃), in which “C*” denotes a carbon atom from which a hydrogen atom is removed to form a secondary or tertiary alkyl radical. Examples of substituted (C₁-C₅₀)alkylene are substituted (C₁-C₂₀)alkylene, —CF₂—, —C(O)—, and —(CH₂)₁₄C(CH₃)₂(CH₂)₅— (i.e., a 6,6-dimethyl substituted normal-1,20-eicosylene). Since as mentioned previously two R^{S} may be taken together to form a (C₁-C₁₈)alkylene, examples of substituted (C₁-C₅₀)alkylene also include 1,2-bis(methylene)cyclopentane, 1,2-bis(methylene)cyclohexane, 2,3-bis(methylene)-7,7-dimethyl-bicyclo[2.2.1]heptane, and 2,3-bis(methylene)bicyclo [2.2.2] octane.

The term “(C₃-C₄₀)cycloalkylene” means a cyclic diradical (i.e., the radicals are on ring atoms) of from 3 to 40 carbon atoms that is unsubstituted or substituted by one or more R^{S}.

The term “heteroatom,” refers to an atom other than hydrogen or carbon. Examples of heteroatoms include O, S, S(O), S(O)₂, Si(R^{C})₂, P(R^{P}), N(R^{N}), —N═C(R^{C})₂, —Ge(R^{C})₂—, or —Si(R^{C})—, where each R^{C}, each R^{N}, and each R^{P} is unsubstituted (C₁-C₁₈)hydrocarbyl or —H.

The term “heterohydrocarbon” refers to a molecule or molecular framework in which one or more carbon atoms are replaced with a heteroatom.

The term “(C₁-C₄₀)heterohydrocarbyl” means a heterohydrocarbon radical of from 1 to 40 carbon atoms and the term “(C₁-C₄₀)heterohydrocarbylene” means a heterohydrocarbon diradical of from 1 to 40 carbon atoms, and each heterohydrocarbon has one or more heteroatoms. The radical of the heterohydrocarbyl is on a carbon atom or a heteroatom, and diradicals of the heterohydrocarbyl may be on: (1) one or two carbon atom, (2) one or two heteroatoms, or (3) a carbon atom and a heteroatom. Each (C₁-C₅₀)heterohydrocarbyl and (C₁-C₅₀)heterohydrocarbylene may be unsubstituted or substituted (by one or more R^{S}), aromatic or non-aromatic, saturated or unsaturated, straight chain or branched chain, cyclic (including mono-and poly-cyclic, fused and non-fused polycyclic), or acyclic.

The (C₁-C₄₀)heterohydrocarbyl may be unsubstituted or substituted (C₁-C₄₀)heteroalkyl, (C₁-C₄₀)hydrocarbyl-O—, (C₁-C₄₀)hydrocarbyl-S—, (C₁-C₄₀)hydrocarbyl-S(O)—, (C₁-C₄₀)hydrocarbyl-S(O)₂—, (C₁-C₄₀)hydrocarbyl-Si(R^{C})₂—, (C₁-C₄₀)hydrocarbyl-N(R^{N})—, (C₁-C₄₀)hydrocarbyl-P(RP)—, (C₂-C₄₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl-(C₁-C₂₀)heteroalkylene, (C₁-C₄₀)heteroaryl, (C₁-C₁₉)heteroaryl-(C₁-C₂₀)alkylene, (C₆-C₂₀)aryl-(C₁-C₁₉)heteroalkylene, or (C₁-C₁₉)heteroaryl-(C₁-C₂₀)heteroalkylene.

The term “(C₄-C₄₀)heteroaryl” means an unsubstituted or substituted (by one or more R^{S}) mono-, bi- or tricyclic heteroaromatic hydrocarbon radical of from 4 to 40 total carbon atoms and from 1 to 10 heteroatoms, and the mono-, bi-or tricyclic radical comprises 1, 2 or 3 rings, respectively, wherein the 2 or 3 rings independently are fused or non-fused and at least one of the 2 or 3 rings is heteroaromatic. Other heteroaryl groups (e.g., (Cₓ-C_{y})heteroaryl generally, such as (C₄-C₁₂)heteroaryl) are defined in an analogous manner as having from x to y carbon atoms (such as 4 to 12 carbon atoms) and being unsubstituted or substituted by one or more than one R^{S}. The monocyclic heteroaromatic hydrocarbon radical is a 5-membered or 6-membered ring. The 5-membered ring has 5 minus h carbon atoms, wherein h is the number of heteroatoms and may be 1, 2, or 3;and each heteroatom may be O, S, N, or P. Examples of 5-membered ring heteroaromatic hydrocarbon radicals are pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring has 6 minus h carbon atoms, wherein h is the number of heteroatoms and may be 1 or 2 and the heteroatoms may be N or P. Examples of 6-membered ring heteroaromatic hydrocarbon radicals are pyridine-2-yl; pyrimidin-2-yl; and pyrazin-2-yl. The bicyclic heteroaromatic hydrocarbon radical can be a fused 5,6-or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-; 5,6,6-; 6,5,6-; or 6,6,6-ring system. An example of the fused 5,6,5-ring system is 1,7-dihydropyrrolo [3,2-f] indol-1-yl. An example of the fused 5,6,6-ring system is 1H-benzo [f] indol-1-yl. An example of the fused 6,5,6-ring system is 9H-carbazol-9-yl. An example of the fused 6,5,6-ring system is 9H-carbazol-9-yl. An example of the fused 6,6,6-ring system is acrydin-9-yl.

The disclosed ethylene-alpha-olefin compositions can be produced by multiple different catalyst systems. The examples described below are included to fully convey the scope of the disclosure to those skilled in the art. The ethylene-alpha-olefin composition can be polymerized using a catalyst system comprising a metal--ligand complex of Structure I to form a first ethylene-based polymer; and polymerizing ethylene and the comonomers in the presence of a catalyst system comprising a Ziegler/Natta catalyst, to form a second ethylene-based polymer; and wherein Structure 1 is as follows:

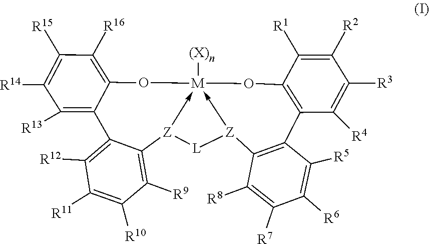

wherein:

M is titanium, zirconium, or hafnium, each, independently, being in a formal oxidation state of +2, +3, or +4; and n is an integer from 0 to 3, and wherein when n is 0, X is absent; and each X, independently, is a monodentate ligand that is neutral, monoanionic, or dianionic; or two Xs are taken together to form a bidentate ligand that is neutral, monoanionic, or dianionic; and X and n are chosen, in such a way, that the metal-ligand complex of formula (I) is, overall, neutral; and each Z, independently, is O, S, N (C₁-C₄₀)hydrocarbyl, or P (C₁-C₄₀)hydrocarbyl; and wherein the Z-L-Z fragment is comprised of formula (1):

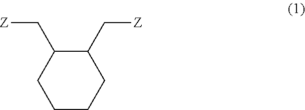

R¹ through R¹⁶ are each, independently, selected from the group consisting of the following: a substituted or unsubstituted (C₁-C₄₀)hydrocarbyl, a substituted or unsubstituted (C₁-C₄₀)heterohydrocarbyl, Si(R^{C})₃, Ge(R^{C})₃, P(R^{P})₂, N(R^{N})₂, OR^{C}, SR^{C}, NO₂, CN, CF₃, R^{C}S(O)—, R^{C}S(O)₂—, (R^{C})₂C═N—, R^{C}(O)O—, R^{C}OC(O)—, R^{C}(O)N(R)—, (R^{C})₂NC(O)—, halogen atom, hydrogen atom; and wherein each R^{C} is independently a (C1-C30)hydrocarbyl; R^{P} is a (C1-C30)hydrocarbyl; and R^{N} is a (C1-C30)hydrocarbyl; and wherein, optionally, two or more R groups (from R¹ through R¹⁶) can combine together into one or more ring structures, with such ring structures each, independently, having from 3 to 50 atoms in the ring, excluding any hydrogen atom. Two or more R groups from R⁹ through R¹³, or R⁴ through R⁸ can combine into one or more ring structures, with such ring structures each, independently, having from 3 to 50 atoms in the ring, excluding any hydrogen atom. R¹ and R¹⁶ can each be as shown in formula 2:

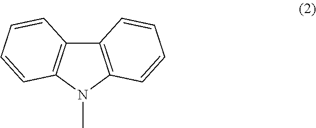

Each of the aryl, heteroaryl, hydrocarbyl, heterohydrocarbyl, Si(R^{C})₃, Ge(R^{C})₃, P(R^{P})₂, N(R^{N})₂, OR^{C}, SR^{C}, R^{C}S(O)—, R^{C}S(O)₂—, (R^{C})₂C═N—, R^{C}(O)O—, R^{C}OC(O) —, R^{C}(O)N(R)—, (R^{C})₂NC(O)—, hydrocarbylene, and heterohydrocarbylene groups, independently, is unsubstituted or substituted with one or more R^{S} substituents; and each R^{S} independently is a halogen atom, polyfluoro substitution, perfluoro substitution, unsubstituted (C₁-C₁₈)alkyl, F₃C—, FCH₂O—, F₂HCO—, F₃CO—, R₃Si—, R₃Ge—, RO—, RS—, RS(O)—, RS(O)₂—, R₂P—, R₂N—, R₂C═N—, NC—, RC(O)O—, ROC(O)—, RC(O)N(R)—, or R₂NC(O)—, or two of the R^{S} are taken together to form an unsubstituted (C₁-C₁₈)alkylene, wherein each R independently is an unsubstituted (C₁-C₁₈)alkyl.

The catalyst system used for producing the ethylene/a-olefin interpolymer can be a catalyst system comprising bis((2-oxoyl-3-(dibenzo-1H-pyrrole-1-yl)-5-(methyl)phenyl)-2-phenoxymethyl)-methylene-1,2-cyclohexanediylhafnium (IV) dimethyl, represented by the following Structure IA:

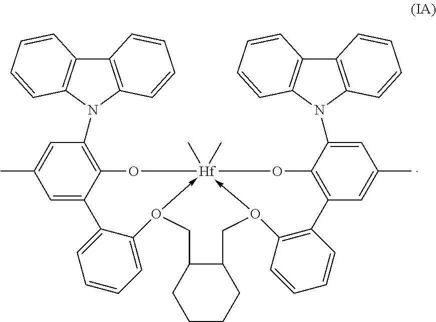

The Ziegler/Natta catalysts suitable for use in the present disclosure are typical supported, Ziegler-type catalysts, which are particularly useful at the high polymerization temperatures of the solution process. Examples of such compositions are those derived from organomagnesium compounds, alkyl halides or aluminum halides or hydrogen chloride, and a transition metal compound. Examples of such catalysts are described in U.S. Pat Nos. 4,612,300; 4,314,912; and 4,547,475; the teachings of which are incorporated herein by reference.

Particularly suitable organomagnesium compounds include, for example, hydrocarbon soluble dihydrocarbylmagnesium, such as the magnesium dialkyls and the magnesium diaryls. Exemplary suitable magnesium dialkyls include, particularly, n-butyl-sec-butylmagnesium, diisopropylmagnesium, di-n-hexylmagnesium, isopropyl-n-butyl-magnesium, ethyl-n-hexyl-magnesium, ethyl-n-butylmagnesium, di-n-octylmagnesium, and others, wherein the alkyl has from 1 to 20 carbon atoms. Exemplary suitable magnesium diaryls include diphenylmagnesium, dibenzylmagnesium and ditolylmagnesium. Suitable organomagnesium compounds include alkyl and aryl magnesium alkoxides and aryloxides and aryl and alkyl magnesium halides, with the halogen-free organomagnesium compounds being more desirable.

Halide sources include active non-metallic halides, metallic halides, and hydrogen chloride. Suitable non-metallic halides are represented by the formula R′X, wherein R′ is hydrogen or an active monovalent organic radical, and X is a halogen. Particularly suitable non-metallic halides include, for example, hydrogen halides and active organic halides, such as t-alkyl halides, allyl halides, benzyl halides and other active hydrocarbyl halides. By an active organic halide is meant a hydrocarbyl halide that contains a labile halogen at least as active, i.e., as easily lost to another compound, as the halogen of sec-butyl chloride, preferably as active as t-butyl chloride. In addition to the organic monohalides, it is understood that organic dihalides, trihalides and other polyhalides that are active, as defined hereinbefore, are also suitably employed. Examples of preferred active non-metallic halides, include hydrogen chloride, hydrogen bromide, t-butyl chloride, t-amyl bromide, allyl chloride, benzyl chloride, crotyl chloride, methylvinyl carbinyl chloride, a-phenylethyl bromide, diphenyl methyl chloride, and the like. Most preferred are hydrogen chloride, t-butyl chloride, allyl chloride and benzyl chloride.

Suitable metallic halides include those represented by the formula MRy-a Xa, wherein: M is a metal of Groups IIB, IIIA or IVA of Mendeleev's periodic Table of Elements; R is a monovalent organic radical; X is a halogen; y has a value corresponding to the valence of M; and “a” has a value from 1 to y. Preferred metallic halides are aluminum halides of the formula AlR₃₋ₐ Xₐ, wherein each R is independently hydrocarbyl, such as alkyl; X is a halogen; and “a” is a number from 1 to 3. Most preferred are alkylaluminum halides, such as ethylaluminum sesquichloride, diethylaluminum chloride, ethylaluminum dichloride, and diethylaluminum bromide, with ethylaluminum dichloride being especially preferred. Alternatively, a metal halide, such as aluminum trichloride, or a combination of aluminum trichloride with an alkyl aluminum halide, or a trialkyl aluminum compound may be suitably employed.

Any of the conventional Ziegler-Natta transition metal compounds can be usefully employed, as the transition metal component in preparing the supported catalyst component. Typically, the transition metal component is a compound of a Group IVB, VB, or VIB metal. The transition metal component is generally, represented by the formulas: TrX′_{4-q} (OR1)q, TrX′_{4-q} (R2)q, VOX′₃ and VO(OR)₃.

Tr is a Group IVB, VB, or VIB metal, preferably a Group IVB or VB metal, preferably titanium, vanadium or zirconium; q is 0 or a number equal to, or less than, 4; X′ is a halogen, and R¹ is an alkyl group, aryl group or cycloalkyl group having from 1 to 20 carbon atoms; and R² is an alkyl group, aryl group, aralkyl group, substituted aralkyls, and the like.

The aryl, aralkyls and substituted aralkys contain 1 to 20 carbon atoms, preferably 1 to 10 carbon atoms. When the transition metal compound contains a hydrocarbyl group, R2, being an alkyl, cycloalkyl, aryl, or aralkyl group, the hydrocarbyl group will preferably not contain an H atom in the position beta to the metal carbon bond. Illustrative, but non-limiting, examples of aralkyl groups are methyl, neopentyl, 2,2-dimethylbutyl, 2,2-dimethylhexyl; aryl groups such as benzyl; cycloalkyl groups such as 1-norbornyl. Mixtures of these transition metal compounds can be employed if desired.

Illustrative examples of the transition metal compounds include TiCl₄, TiBr₄, Ti(OC₂H₅)₃Cl, Ti(OC₂H₅)Cl₃, Ti(OC₄H₉)₃Cl, Ti(OC₃H₇)₂Cl₂, Ti(OC₆H₁₃)₂Cl₂, Ti(OC₈H₁₇)₂Br₂, and Ti(OC₁₂H₂₅)Cl₃, Ti(O-iC₃H₇)₄, and Ti(O-nC₄H₉)₄. Illustrative examples of vanadium compounds include VCl₄, VOCl₃, VO(OC₂H₅)₃, and VO(OC₄H₉)₃. Illustrative examples of zirconium compounds include ZrCl₄, ZrCl₃(OC₂H₅), ZrCl₂(OC₂H₅)₂, ZrCl(OC₂H₅)₃, Zr(OC₂H₅)₄, ZrCl₃(OC₄H₉), ZrCl₂(OC₄H₉)₂, and ZrCl(OC₄H₉)₃.

An inorganic oxide support may be used in the preparation of the catalyst, and the support may be any particulate oxide, or mixed oxide which has been thermally or chemically dehydrated, such that it is substantially free of adsorbed moisture. See U. S. Pat Nos. 4,612,300; 4,314,912; and 4,547,475; the teachings of which are incorporated herein by reference.

The above-described catalyst systems can be rendered catalytically active by contacting it to, or combining it with, the activating co-catalyst, or by using an activating technique, such as those known in the art, for use with metal-based olefin polymerization reactions. Suitable activating co-catalysts, for use herein, include alkyl aluminums; polymeric or oligomeric alumoxanes (also known as aluminoxanes); neutral Lewis acids; and non-polymeric, non-coordinating, ion-forming compounds (including the use of such compounds under oxidizing conditions). A suitable activating technique is bulk electrolysis. Combinations of one or more of the foregoing activating co-catalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Aluminoxanes and their preparations are known at, for example, U.S. Pat. No. 6,103,657. Examples of preferred polymeric or oligomeric alumoxanes are methylalumoxane, triisobutylaluminum-modified methylalumoxane, and isobutylalumoxane.

Exemplary Lewis acid activating co-catalysts are Group 13 metal compounds containing from 1 to 3 hydrocarbyl substituents as described herein. Exemplary Group 13 metal compounds are tri (hydrocarbyl)-substituted-aluminum or tri (hydrocarbyl)-boron compounds. Exemplary Group 13 metal compounds also include tri (hydrocarbyl)-substituted-aluminum or tri(hydrocarbyl)-boron compounds are tri((C₁-C₁₀)alkyl)aluminum or tri((C₆-C₁₈)aryl)boron compounds and halogenated (including perhalogenated) derivatives thereof. Exemplary Group 13 metal compounds are tris(fluoro-substituted phenyl)boranes, or tris(pentafluorophenyl)borane. The activating co-catalyst can be a tris((C₁-C₂₀)hydrocarbyl) borate (e.g., trityl tetrafluoroborate) or a tri((C₁-C₂₀)hydrocarbyl)ammonium tetra((C₁-C₂₀)hydrocarbyl)borane (e.g., bis(octadecyl) methylammonium tetrakis (pentafluorophenyl)borane). As used herein, the term “ammonium” means a nitrogen cation that is a ((C₁-C₂₀)hydrocarbyl)₄N⁺, a ((C₁-C₂₀)hydrocarbyl)₃N(H)⁺, a ((C₁-C₂₀)hydrocarbyl)₂N(H)₂⁺, (C₁-C₂₀)hydrocarbylN(H)₃⁺, or N(H)₄⁺, wherein each (C₁-C₂₀)hydrocarbyl may be the same or different.

Exemplary combinations of neutral Lewis acid activating co-catalysts include mixtures comprising a combination of a tri((C₁-C₄)alkyl)aluminum and a halogenated tri((C₆-C₁₈)aryl)boron compound, especially a tris(pentafluorophenyl)borane. Other examples are combinations of such neutral Lewis acid mixtures with a polymeric or oligomeric alumoxane, and combinations of a single neutral Lewis acid, especially tris(pentafluorophenyl)borane with a polymeric or oligomeric alumoxane. Exemplary ratios of numbers of moles of (metal-ligand complex): (tris(pentafluoro-phenylborane): (alumoxane) [e.g., (Group 4 metal-ligand complex): (tris(pentafluoro-phenylborane): (alumoxane)] are from 1:1:1 to 1:10:30, or from 1:1:1.5 to 1:5:10.

Many activating co-catalysts and activating techniques have been previously taught, with respect to different metal-ligand complexes, in the following U.S. Pat. Nos. 5,064,802; 5,153,157; 5,296,433; 5,321,106 ; 5,350,723; 5,425,872; 5,625,087; 5,721,185; 5,783,512; 5,883,204; 5,919,983; 6,696,379; and 7,163,907. Examples of suitable hydrocarbyloxides are disclosed in U.S. Pat. No. 5,296,433. Examples of suitable Bronsted acid salts for addition polymerization catalysts are disclosed in U.S. Pat. Nos. 5,064,802; 5,919,983; 5,783,512. Examples of suitable salts of a cationic oxidizing agent and a non-coordinating, compatible anion, as activating co-catalysts for addition polymerization catalysts, are disclosed in U.S. Pat. No. 5,321,106. Examples of suitable carbenium salts as activating co-catalysts for addition polymerization catalysts are disclosed in U.S. Pat. No. 5,350,723. Examples of suitable silylium salts, as activating co-catalysts for addition polymerization catalysts, are disclosed in U.S. Pat. No. 5,625,087. Examples of suitable complexes of alcohols, mercaptans, silanols, and oximes with tris(pentafluorophenyl)borane are disclosed in U.S. Pat. No. 5,296,433. Some of these catalysts are also described in a portion of U.S. Pat. No. 6,515,155 B1, beginning at column 50, at line 39, and going through column 56, at line 55, only the portion of which is incorporated by reference herein.

The above-described catalyst systems can be activated to form an active catalyst composition by combination with one or more cocatalysts, such as a cation forming cocatalyst, a strong Lewis acid, or a combination thereof. Suitable cocatalysts for use include polymeric or oligomeric aluminoxanes, especially methyl aluminoxane, as well as inert, compatible, noncoordinating, ion forming compounds. Exemplary suitable cocatalysts include, but are not limited to, modified methyl aluminoxane (MMAO), bis(hydrogenated tallow alkyl) methyl, tetrakis (pentafluorophenyl) borate (1-) amine, triethyl aluminum (TEA), and any combinations thereof.

One or more of the foregoing activating co-catalysts are used in combination with each other. A combination of a mixture of a tri((C₁-C₄)hydrocarbyl)aluminum, tri((C₁-C₄)hydrocarbyl)borane, or an ammonium borate with an oligomeric or polymeric alumoxane compound, can be used.

### Filler

The biaxially-oriented polyethylene film can comprise from 40 to 75 wt. % of a filler, based on the total weight of the film. All individual values of from 40 to 75 wt. % of a filler are also disclosed and incorporated herein. For example, the biaxially-oriented polyethylene film can comprise from 40 to 75 wt. %, from 45 to 70 wt. %, from 45 to 75 wt. %, from 68 to 72 wt. %, from 58 to 62 wt. %, from 48 to 52 wt. % 50 to 70 wt %, from 50 to 60 wt % or from 60 to 70 wt. % of a filler, based on the total weight of the biaxially-oriented polyethylene film.

The filler used in the biaxially-oriented polyethylene film can be, but is not limited to, a calcium carbonate, magnesium carbonate, barium sulfate, magnesium sulfate, aluminum sulfate, magnesium oxide, alumina, mica, talc, silica, clay, glass spheres, titanium dioxide, aluminum hydroxide, zeolites, or a combination thereof. For example, the filler can be calcium carbonate. In embodiments, the filler comprises calcium carbonate.

### Biaxially-Oriented Polyethylene Films, Laminates, and Articles

The biaxially-oriented polyethylene film can have a water vapor transmission rate (WVTR) of greater than 300 g/m²/day at 40.0° C. and at a relative humidity of 60%, where WVTR is measured in accordance with the test method described below. The biaxially-oriented polyethylene film can have a water vapor transmission rate (WVTR) of greater than 400 g/m²/day at 40.0° C. and at a relative humidity of 60%. The biaxially-oriented polyethylene film can have a water vapor transmission rate (WVTR) of greater than 800 g/m²/day at 40.0° C. and at a relative humidity of 60%. The biaxially-oriented polyethylene film can have a water vapor transmission rate (WVTR) of greater than 1000 g/m²/day at 40.0° C. and at a relative humidity of 60%. The biaxially-oriented polyethylene film can have a water vapor transmission rate (WVTR) of greater than 2000 g/m²/day at 40.0° C. and at a relative humidity of 60%. The biaxially-oriented polyethylene film can have a water vapor transmission rate (WVTR) from 300 to 3000 g/m²/day at 40.0° C. and at a relative humidity of 60%. All individual values and subranges from 300 to 3000 are disclosed and incorporated. For example, the biaxially-oriented polyethylene film can have a water vapor transmission rate (WVTR) from 400 to 2500, or 1,000 to 2500 g/m²/day at 40.0° C. and at a relative humidity of 60%. The biaxially-oriented polyethylene film can have an elongation at break of less than 200% in both the machine direction and the transverse direction, where elongation can be measured in accordance with the test method described below. The biaxially-oriented polyethylene film can have an elongation at break of less than100% in both the machine direction and the transverse direction, where elongation can be measured in accordance with the test method described below. The biaxially-oriented polyethylene film can have an elongation at break of less than 60% in both the machine direction and the transverse direction, where elongation can be measured in accordance with the test method described below. The biaxially-oriented polyethylene film can have an elongation at break from 60 to 200% in both the machine direction and the transverse direction, where elongation can be measured in accordance with the test method described below. All individual values from 60 to 200% are included and disclosed. For example, the biaxially-oriented polyethylene film can have an elongation at break from 60 to 100% in both the machine direction and the transverse direction, where elongation can be measured in accordance with the test method described below.

The basis weight of the biaxially-oriented polyethylene film is not particularly limited but may be from 3 to 65 gsm. The basis weight of the biaxially-oriented polyethylene film can depend on several factors including the desired properties of the film, the end use application of the film, the equipment available to manufacture the film, the cost allowed by the application, and other factors. All individual values and subranges of from 3 to 65 gsm are included and disclosed herein. For example, the biaxially-oriented polyethylene film can have a basis weight of from 5 to 60 gsm, 10 to 50 gsm, 15 to 40 gsm, 15 to 35 gsm, 15 to 30 gsm, 15 to 20 gsm, or 20 to 25 gsm.

The film can have a transverse direction tensile strength greater than 0.3 N/in/gsm when measured using the procedure described below. The film can have a transverse direction tensile strength greater than 0.4 N/in/gsm when measured using the procedure described below. The film can have a transverse direction tensile strength greater than 0.5 N/in/gsm when measured using the procedure described below. The film can have a transverse direction tensile strength greater than 0.6 N/in/gsm when measured using the procedure described below. The film can have a transverse direction tensile strength greater than 0.8 N/in/gsm when measured using the procedure described below. The film can have a transverse direction tensile strength greater than 1.5 N/in/gsm when measured using the procedure described below. The film can have a transverse direction tensile strength from 0.3 to 1.8 N/in/gsm when measured using the procedure described below. All individual values from 0.3 to 1.8 N/in/gsm are included and disclosed. For example, the film can have a transverse direction tensile strength from 0.4 to 1.7 N/in/gsm when measured using the procedure described below.

The film can have a machine direction tensile strength greater than 0.3 N/in/gsm when measured using the procedure described below. The film can have a machine direction tensile strength greater than 0.4 N/in/gsm when measured using the procedure described below. The film can have a machine direction tensile strength greater than 0.8 N/in/gsm when measured using the procedure described below. The film can have a machine direction tensile strength greater than 1.0 N/in/gsm when measured using the procedure described below. The film can have a machine direction tensile strength greater than 1.5 N/in/gsm when measured using the procedure described below. The film can have a machine direction tensile strength from 0.3 to 1.8 N/in/gsm when measured using the procedure described below. All individual values and subranges from 0.3 to 1.8 N/in/gsm are included and disclosed. For example, the film can have a machine direction tensile strength from 0.4 to 1.7 N/in/gsm when measured using the procedure described below.

The biaxially-oriented polyethylene film can be made by methods known to those skilled in the art The biaxially-oriented film can be produced by a double bubble process The biaxially-oriented film can be a tenter frame biaxially-oriented polyethylene film.

The disclosed biaxially-oriented polyethylene films may be incorporated into laminates such as film/non-woven laminates. Typical non-wovens for use in such laminates can be spunlaid, airlaid, carded webs, or composities thereof. Typical non-woven composites for use in laminates with a breathable film of the present disclosure include three beams of spunbond, (e.g., S/S/S), a spunbond/meltblown/spunbond composite (e.g., S/M/S), and others. Common methods for joining the film to the non-wovens include, for example, bonded hot melt adhesive lamination, ultra-sonic bonding, and thermal bonding through a calendar or nip roll.

The disclosed film can be biaxially-oriented using a tenter frame sequential biaxial-orientation process or a double bubble orientation process. In general, with a tenter frame sequential biaxial orientation process, the tenter frame is incorporated as part of an extrusion line. After extruding from a flat die, the film is cooled down on a chill roll, and is immersed into a water bath. The cast film is then passed onto a series of rollers with different revolving speeds to achieve stretching in the machine direction. There are several pairs of rollers in the MD stretching segment of the fabrication line and are all oil heated. The paired rollers work sequentially as pre-heated rollers, stretching rollers, and rollers for relaxing and annealing. The temperature of each pair of rollers is separately controlled. After stretching in the machine direction, the film web is passed into a tenter frame hot air oven with heating zones to carry out stretching in the transverse direction. The first several zones are for pre-heating, followed by zones for stretching, and then the last zones for annealing.

In general, with a double bubble orientation process a thick-walled tube is extruded using a circular die. The tube is simultaneously inflated with air, pulled downward, and collapsed. The air inflation provides orientation to the film in the transverse direction while the downward pull and collapse provides orientation in the machine direction. As similar machine and transverse orientations are achieved a balanced film is produced.

The biaxially-oriented polyethylene film can be oriented in the machine direction at a draw ratio of 2:1 to 9:1, 3:1 to 9:1, 2:1 to 6:1 5:1 to 6:1, 5:5 to 6:6 or any of the ratios in-between, and in the transverse direction at a draw ratio of 2:1 to 9:1, 3:1 to 9:1, 2:1 to 6:1, 5:1 to 6:1, 5:5 to 6:6 or any of the ratios in-between.

The presently disclosed biaxially-oriented polyethylene film may be incorporated into various articles such as diapers, training pants, feminine hygiene products, adult incontinence products, medical drapes, medical gowns, surgical suits, and others. The biaxially-oriented polyethylene film can be referred to as a breathable film. In articles such as diapers, training pants, feminine hygiene products, and adult incontinence products, a breathable, biaxially-oriented polyethylene film is also often referred to as a backsheet. In medical products, a breathable film is often referred to as the “barrier layer” as the breathable film can prevent contamination from a health care worker to a patient and vice versa. Breathable films can be incorporated into such articles using techniques known to those of skill in the art based on the teachings herein.

### TEST METHODS

### Density

Density is measured in accordance with ASTM D792, and expressed in grams/cm³ (g/cm³).

### Melt Index (I₂)

Melt index (I₂) is measured in accordance with ASTM D-1238 at 190° C. at 2.16 kg. The values are reported in g/10 min, which corresponds to grams eluted per 10 minutes.

### Basis Weight

The sample is cut into 100 cm² samples and weighed on a balance. This weight is then multiplied by 100 to convert the measurement to grams per square meter (gsm).

### Water Vapor Transmission Rate (WVTR)

Water Vapor Transmission Rate (WVTR) is measured based on a standard cup method of ASTM E96-16 and GB/T12704.2 (2009). A test dish is filled with 10 ml of distilled water. A specimen is attached to the test dish, and the dish is sealed with a washer and ring cap. The weight of the dish assembly is recorded as mass (Wa). The dish assembly is placed into a controlled chamber with constant temperature (40.0° C.) and humidity (60%). After four (4) hours, the dish assembly is removed from the controlled chamber and weighed where the mass is recorded as (Wb). WVTR is calculated by the following equation:

$$WVTR = \frac{24 ( Wa - Wb )}{S * T} [ g / {m}^{2} * day ]$$

WVTR: Water Vapor Transmission Rate, [g/m²*day]
Wa: The mass of test dish assembly before test, [g]
Wb: The mass of test dish assembly after test, [g]
S: Testing area=0.0032 m², [m²]
T: Testing time=4 hours, [h]

### Tensile Strength and Elongation at break

Machine direction and transverse direction tensile strength along with film elongation at break is measured in accordance with ASTM D882. An Instron 5965 is used for the measurements. Samples are cut into 25.4*50 mm via flat clamping jars. Test speed is 500 mm/min. Tensile strength and elongation at break is measured by stretching a 1 inch width film while recording the load until the film breaks.

### Hydrohead

Hydrohead is measured according to ISO 811 in an M018 type hydrostatic head tester from SDLATLAS. Circular, 100 cm² breathable samples are prepared. Pressure is gradually increased at a speed of 60 cm HO/min. Water pressure needed to cause 3 or more failure positions is recorded. Results are reported as a column height of water (cm). Higher numbers indicated better penetration resistance.

### Improved Comonomer Composition Distribution (iCCD)

The Improved method for comonomer content analysis (iCCD) was developed in 2015 (Cong and Parrott et al., WO2017040127A1). The iCCD test is performed with a Crystallization Elution Fractionation instrument (CEF) (PolymerChar, Spain) equipped with a IR-5 detector (PolymerChar, Spain) and two angle light scattering Model 2040 detectors (Precision Detectors, currently Agilent Technologies). Ortho-dichlorobenzene (ODCB, 99% anhydrous grade or technical grade) is used. Silica gel 40 (particle size 0.2˜0.5 mm, catalogue number 10181-3) can be obtained from EMD Chemicals and used to pack columns to dry the 1,2-dichlorobenzene (ODCB) solvent. The ODCB solvent drying columns are installed at the inlet of solvent delivery system (pump). The CEF instrument is equipped with an autosampler with N2 purging capability. ODCB is purged with dried nitrogen (N2) for one hour before use. Samples are prepared with an autosampler at 4 mg/ml (unless otherwise specified) under shaking at 160.0° C. for 1 hour. The injection volume is 300 μl. The temperature profile of the iCCD is: crystallization at 3.0° C./min from 105.0° C. to 30.0° C., the thermal equilibrium at 30.0° C. for 2 minute (including Soluble Fraction Elution Time set as 2 minutes), elution at 3.0° C./min from 30.0° C. to 140.0° C. The flow rate during crystallization is 0.0 ml/min. The flow rate during elution is 0.50 ml/min. Data is collected at one data point/second.

The iCCD column is packed with gold coated nickel particles (Bright 7GNM8-NiS, Nippon Chemical Industrial Co.) in 15 cm (length)X¼″ (ID) stainless tubing. The column is packed and conditioned according to the reference (Cong, R.; Parrott, A.; Hollis, C.; Cheatham, M. WO2017040127A1). The final pressure with 1,2,4-trichlorobenzene (TCB) slurry packing is 150 Bars.

Column temperature calibration is performed by using a mixture of the Reference Material Linear homopolymer polyethylene (having zero comonomer content, Melt index (I₂) of 1.0, polydispersity M_{w}/Mₙ approximately 2.6 by conventional gel permeation chromatography, 1.0 mg/ml) and Eicosane (2 mg/ml) in 1,2-Dichlorobenzene (ODCB). iCCD temperature calibration consists of four steps: (1) Calculating the delay volume defined as the temperature offset between the measured peak elution temperature of Eicosane minus 30.00° C.; (2) Subtracting the temperature offset of the elution temperature from iCCD raw temperature data. It is noted that this temperature offset is a function of experimental conditions, such as elution temperature, elution flow rate, etc.; (3) Creating a linear calibration line transforming the elution temperature across a range of 30.00° C. and 140.00° C. so that the linear homopolymer polyethylene reference has a peak temperature at 101.0° C., and Eicosane has a peak temperature of 30.0° C.; (4) For the soluble fraction measured isothermally at 30.0° C., the elution temperature below 30.0° C. is extrapolated linearly by using the elution heating rate of 3.0° C./min according to the reference (Cerk and Cong et al., U.S. Pat. No. 9,688,795).

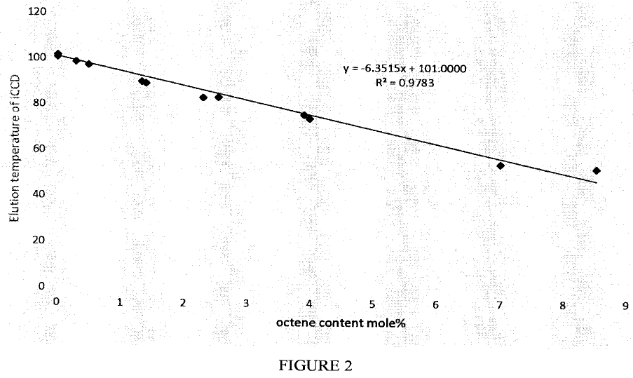

The comonomer content versus elution temperature of iCCD is constructed by using 12 reference materials (ethylene homopolymer and ethylene-octene random copolymers made with single site metallocene catalyst, having ethylene equivalent weight average molecular weight ranging from 35,000 to 128,000. Cong et al., Macromolecules 2011, 44, 3062). Octene content of the reference materials are analyzed by 13C NMR. All of these reference materials are analyzed the same way as specified previously at 4 mg/mL. The reported elution peak temperatures follow the FIG. 2.

The molecular weight of the polymer and the molecular weight of the polymer fractions are determined directly from the LS detector (90 degree angle) and the concentration detector (IR-5) according to the Rayleigh-Gans-Debys approximation (Striegel and Yau, Modern Size Exclusion Liquid Chromatogram, Page 242 and Page 263) by assuming the form factor of 1 and all the virial coefficients are equal to zero. Baselines are subtracted from the LS, and concentration detector chromatograms. Integration windows are set to integrate all the chromatograms in the elution temperature (temperature calibration is specified above) range from 23.0 to 120.0° C.

The Wt % of the copolymer eluting between 65.0° C. and 95.0° C. in the iCCD is calculated as the integrated area of the baseline subtracted iCCD elution profile between 65.0° C. and 95.0° C. divided by the total integrated area of the baseline subtracted iCCD, multiplied by 100%.

The calculation of Molecular Weight (Mw) from iCCD includes the following steps:
(1) Measuring the interdetector offset: The offset is defined as the geometric volume offset between the LS with respect to concentration detector. It is calculated as the difference in the elution volume (mL) of the polymer peak between the concentration detector and LS chromatograms. It is converted to the temperature offset by using the elution thermal rate and the elution flow rate. A linear high density polyethylene (having zero comonomer content, Melt index (I₂) of 1.0, polydispersity Mw/Mn approximately 2.6 by conventional gel permeation chromatography) is used. The same experimental conditions as the normal iCCD method above are used except the for the following parameters: crystallization is at 10.0° C./min from 140.0° C. to 137.0° C., the thermal equilibrium is at 137.0° C. for 1 minute as Soluble Fraction Elution Time, soluble fraction (SF) time of 7 minutes, elution at 3.0° C./min from 137.0° C. to 142.0° C. The flow rate during crystallization is 0.0 ml/min. The flow rate during elution is 0.80 ml/min. Sample concentration is 1.0 mg/ml.
(2) Each LS datapoint in LS chromatogram is shifted to correct for the interdetector offset before integration.
(3) The baseline is subtracted and the LS and concentration chromatograms are integrated for the entire eluting temperature range of Step (1). The MW detector constant is calculated by using a known MW HDPE sample (12 of 1.0, Mw/Mn ˜2.6) and the area ratio of the LS and concentration integrated signals.
(4) The molecular weight of the polymer is calculated by using the ratio of the integrated light scattering detector (90 degree angle) to the concentration detector and using the MW detector constant. With the measured MW detector constant, NIST NBS 1475a analyzed using the same method specified in (1) above leads to a molecular weight of 58,000.

The molecular weight (Mw) of the copolymer eluting between 65.0° C. and 95.0° C. in the iCCD is calculated from the total integrated area of the light scattering detector results divided by the total area of the IR-5 concentration detector results and IR-5 concentration detector constants.

### Triple Detector Gel Permeation Chromatography (GPC)

The composition of polymer resins and blends are tested using PolymerChar GPC-IR high temperature GPC. The GPC system consists of a 150.0° C. high temperature chromatograph equipped with an infrared detector, a light scattering detector and a viscometer. Four PL Mixed A columns are installed in series before the IR-5 detector in the detector oven. 1,2,4-trichlorobenzene is used as liquid phase. The GPC is calibrated using a series of narrow molecular weight (Mw) polystyrene standards. The Mw of the polystyrene standards varies from 580 to 9,835,000 g per mole. A fifth order polynomial is used to fit the respective polystyrene calibration points. The polystyrene standard peak molecular weights are converted to polyethylene molecular weights using a conversion factor of 0.43. Sample preparation is done with an autosampler at 2 mg/mL under shaking at 160.0° C. for 3 hours. The injection volume is 200 ml. The temperature of the GPC is 150.0° C. and the flow rate is 1 mL/min.

### NMR

Sample is dissolved in TCE-d2 at 120.0° C. for 6 hours to obtain a homogenous solution. All NMR data is acquired at 120.0° C. on a Bruker AVANCE II 400 MHz spectrometer operating at a ¹³C resonance frequency of 100.6 MHz. A 10 mm BBO probe is employed. Chemical shifts are given in ppm (parts per million) relative to TCE-d2. Zgig is used as the pulse program of ¹³C NMR with an observe pulse of 90 degrees. Recycle delay is set to 6 seconds. (see Cong et al., Macromolecules 2011) The monomer wt. % has an error limit of +/−0.3%.

### EXAMPLES

The following examples are presented to further illustrate the present disclosure in detail but are not to be construed as limiting the scope of the claims.

The raw materials used in the Inventive Examples (Inv. Ex.) and the Comparative Examples (Comp. Ex.) are explained in Table 1 as follows:

TABLE 1
Raw Materials.

| | | | MI | |
|---|---|---|---|---|
| | | Density | (190° C., | |
| Supplier | Materials | (g/cc) | 2.16 kg) | Notes |
| The Dow | DOWLEX ™ | 0.926 | 1.0 | Ethylene-alpha- |
| Chemical | 2049G | | | olefin Copolymer |
| Company | | | | |
| The Dow | DOWLEX ™ | 0.920 | 1.0 | Ethylene-alpha- |
| Chemical | 2045G | | | olefin Copolymer |
| Company | | | | |
| The Dow | DOWLEX ™ | 0.919 | 6.0 | Ethylene-alpha- |
| Chemical | 2035G | | | olefin Copolymer |
| Company | | | | |
| The Dow | INNATE ™ | 0.926 | 1.7 | Ethylene-alpha- |
| Chemical | TF80 | | | olefin Copolymer |
| Company | | | | |
| The Dow | CEFORE ™ | 0.918 | 1.0 | Ethylene-alpha- |
| Chemical | 1211 | | | olefin Copolymer |
| Company | | | | |
| The Dow | ELITE ™ | 0.915 | 3.5 | Ethylene-alpha- |
| Chemical | 5220G | | | olefin Copolymer |
| Company | | | | |
| Exxon Mobil | EXCEED | 0.927 | 1.3 | Ethylene-alpha- |
| Chemical | 1327 | | | olefin Copolymer |
| Exxon Mobil | EXCEED | 0.918 | 1.0 | Ethylene-alpha- |
| Chemical | 1018 | | | olefin Copolymer |
| Imerys | FilmLink ® | | | calcium carbonate |
| | 520 | | | filler with a median |
| | | | | particle size |
| | | | | (D50) of 2 microns, |
| | | | | reported by vendor |
| BASF | Irganox ® | | | Antioxidant |
| | B900 | | | |

Experimental and comparative films are created using a twin-screw extruding compounding line. The compounding formulation for the comparative and inventive examples is about 30-50 wt. % of the polymer (e.g., ethylene-alpha-olefin copolymer), 50-70 wt. % CaCO₃, and 2000 ppm IRGANOX B900. Compositions are extruded using a Coperion ZSK 40 McPlus twin screw extruder at a screw speed of 250rpm, with barrel 1 at 120.0° C., barrel 2-15 at 180.0° C., and the die at 180.0° C. Output is 40 kg/h with 100% CaCO₃ side feeding.

After compounding, the 400 um mono-layer casting sheet is prepared on a Davis-Standard casting line using 3 single screw extruders. Screw diameter is 32 mm with an L/D of 30:1. Zone 1 is set at 210.0° C., Zone 2 at 230.0° C., Zone 3 at 250.0° C. and Zone 4 at 250.0° C. A T-die is used with a die width of 500 mm and a die gap of 1 mm. Output is set at 20 kg/h. Bi-orientation of the resulting sheet is performed on a Brückner Karo IV Laboratory stretching machine. The structures of the resulting films are outlined below in Table 2.

TABLE 2
Inventive and Comparative Film structures

| Film | Structure |
|---|---|
| Comparative | 50 wt. % ELITE ™M 5220G + 50 wt. % |
| example 1 (CE1) | Filmlink 520 |
| Comparative | 50 wt. % INNATETM TF80 + 50 wt. % |
| example 2 (CE2) | Filmlink 520 |
| Comparative | 50 wt. % CEFORETM 1211 + 50 wt. % |
| example 3 (CE3) | Filmlink 520 |
| Comparative | 50 wt. % DOWLEXTM 2035 + 50 wt. % |
| example 4 (CE4) | Filmlink 520 |
| Inventive | 50 wt. % DOWLEXTM 2045 + 50 wt. % |
| example 1 (IE1) | Filmlink 520 |
| Inventive | 50 wt. % Exceed 1018 + 50% |
| example 2 (IE2) | Filmlink 520 |
| Inventive | 40 wt. % DOWLEXTM2045 + 60% |
| example 3 (IE3) | Filmlink 520 |
| Inventive | 30 wt. % DOWLEXTM2045 + 70% |
| example 4 (IE4) | Filmlink 520 |
| Inventive | 50 wt. % Exceed1327 + 50 wt. % |
| example 5 (IE5) | Filmlink 520 |
| Inventive | 50 wt. % DOWLEXTM 2049 + 50 wt. % |
| example 6 (IE6) | Filmlink 520 |

Comparative example 1 was prepared by casting MDO process. The compounded compositions are extruded using a Dr. Collin cast line with one 30 millimeter extruder and three 25 millimeter extruders to produce the samples. All extruders are running the same composition so that conceptually in each case the produced film is equivalent to a monolayer film. Zone 1 is set at 190.0° C., Zone 2 at 210.0° C., Zone 3 at 220.0° C. and Zone 4-6 at 230°.0C. After extrusion, the film goes through reheating, stretching, annealing, cooling, and winding onto rolls. Sample films are oriented in the machine direction with stretch ratios of 5:1 at below processing conditions.

TABLE 3
Machine Direction Orientation Processing Parameters

| Pre-heating | | Stretching | Tempering | Stretching | Tempering |
|---|---|---|---|---|---|
| group | | Group I | Group I | Group II | Group II |
| (° C.) | | (° C.) | (° C.) | (° C.) | (° C.) |
| 70.0 | 80.0 | 90.0 | 90.0 | 95.0 | 55.0 |

The 400 um mono-layer casting sheets are stretched at different temperatures and stretching ratios (5×5, 6×6). Bi-orientation stretching results are summarized in Table 4. Sheets that can be bi-orientationaly stretched without breaking or generating holes, are marked as Y. If after stretching, the resulting film is broken or has holes, it is marked as N.

TABLE 4
Resin properties and Bi-orientation stretching results

| | | | | | Wt % | Mw of | |
|---|---|---|---|---|---|---|---|
| | | | | | copolymer | copolymer | |
| | | | | | eluting | eluting | |
| | | | | | between | between | Can be |
| | | | MI | Comomoner | 65.0° C. and | 65.0° C. and | stretched |
| | | Density | (190.0° C., | type/ | 95.0° C. in | 95.0° C. in | to a film |
| | Resin | (g/cc) | 2.16 kg) | content wt % | iCCD | iCCD | or not |
| IE1 | DOWLEX ™ | 0.920 | 1.0 | Octene/10% | 72.57 | 117,455 | Y |
| | 2045 | | | | | | |
| IE2 | EXCEED ™ | 0.918 | 1.0 | Hexene/7% | 90.76 | 119,439 | Y |
| | 1018 | | | | | | |
| IE3 | DOWLEX ™ | 0.920 | 1.0 | Octene/10% | 72.57 | 117,455 | Y |
| | 2045 | | | | | | |
| IE4 | DOWLEX ™ | 0.920 | 1.0 | Octene/10% | 72.57 | 117,455 | Y |
| | 2045 | | | | | | |
| IE5 | EXCEED ™ | 0.927 | 1.3 | Hexene/5% | 82.34 | 107,106 | Y |
| | 1327 | | | | | | |
| IE6 | DOWLEX ™ | 0.926 | 1.0 | Octene/7% | 75.46 | 104,652 | Y |
| | 2049 | | | | | | |
| CE2 | INNATE ™ | 0.926 | 1.7 | Octene/8% | 34.57 | 80,101 | N |
| | TF80 | | | | | | |
| CE3 | CEFORE ™ | 0.919 | 1.0 | Butene/7% | 77.12 | 126,969 | N |
| | 1211 | | | | | | |
| CE4 | DOWLEX ™ | 0.919 | 6.0 | Octene/12% | 71.84 | 74,945 | N |
| | 2035 | | | | | | |

The Inventive and Comparative Films are tested in accordance with the test methods described above. The results of testing are shown in Table 5 below:

TABLE 5
Film Properties

| Test Method | CE 1 | IE 1 | IE 2 | IE 4 | IE 5 |
|---|---|---|---|---|---|
| Stretch | 90, 95 | 112 | 112 | 112 | 114 |
| Temperature | | | | | |
| Stretch Ratio | 5 in MD | 6*6 | 6*6 | 6*6 | 6*6 |
| Basic Weight gsm | 19 | 17 | 17 | 22 | 19 |
| MD tensile | 29.54 | 23.22 | 28.71 | 19.13 | 8.54 |
| strength N/in | | | | | |
| MD tensile | 1.55 | 1.37 | 1.69 | 0.87 | 0.45 |
| strength N/in/gsm | | | | | |
| MD elongation at | 72.93 | 49.78 | 62.85 | 42.73 | 19.98 |
| break % | | | | | |
| TD tensile | 2.37 | 12.6 | 27.18 | 18.2 | 8.08 |
| strength N/in | | | | | |
| TD tensile | 0.12 | 0.74 | 1.6 | 0.83 | 0.43 |
| strength N/in/gsm | | | | | |
| TD elongation at | 219.07 | 39.76 | 58.76 | 37.47 | 18.52 |
| break % | | | | | |
| WVTR | 368.4 | 487.6 | 326.5 | 1108.5 | 2702.35 |
| (g/m²*day) | | | | | |
| Hydrohead | 84.0 | 230.95 | 267.65 | 196.7 | 106.75 |
| (g/m²*day) | | | | | |

As can be seen from the above, all of the inventive samples show higher transverse (TD) tensile strength even at lower basic weight than the comparative example. In the inventive examples, a tensile strength of at least 0.43 N/inch/gsm is reached even at a CaCO₃ loading of 70 wt. %. In typical breathable backsheets, CaCO₃ loading is less than 55 wt % to maintain TD tensile strength.

1. A biaxially-oriented polyethylene film comprising:
a. from 25 to 60 wt. % of an ethylene-alpha-olefin copolymer comprising i) an ethylene monomer and 1-octene or 1-hexene comonomer, ii) an amount of copolymer eluting in an elution profile via improved comonomer composition distribution (iCCD) analysis method between 65.0° C. and 95.0° C. of at least 50 wt. %, and iii) a molecular weight (Mw) in the elution profile via improved comonomer composition distribution (iCCD) analysis method between 65.0° C. and 95.0° C. of greater than 90,000 g/mol; and
b. from 40 to 70 wt. % of a filler;
and wherein the film has a water vapor transmission rate of greater than 300 g/m²/day at 40.0° C. and at a relative humidity of 60%, and an elongation at break of less than 200% in both the machine direction and the transverse direction.

2. The film of claim 1, wherein the ethylene-alpha-olefin copolymer comprises a molecular weight (Mw) in the elution profile via improved comonomer composition distribution (iCCD) analysis method between 65.0° C. and 95.0° C. of less than 250,000 g/mol.

3. The film of claim 1, wherein the film is a tenter frame biaxially-oriented polyethylene film.

4. The film of claim 1, wherein the filler comprises calcium carbonate.

5. The film of claim 1, wherein the film has a transverse direction tensile strength greater than 0.3 N/in/gsm.

6. The film of claim 1, wherein the film has a transverse direction and machine direction tensile strength greater than 0.3 N/in/gsm.

7. The film of claim 1, wherein the film is produced by a double bubble process.

8. The film of claim 1, wherein the ethylene-alpha-olefin copolymer has a melt index (I₂) of less than 6.0 g/10 min and greater than 0.5 g/10 min, where melt index (I₂) is measured in accordance with ASTM D 1238 at 190° C. and a 2.16 kg load.

9. The film of claim 1, wherein the ethylene-alpha-olefin copolymer has a density of from 0.910 g/cm³ to 0.940 g/cm³.

10. The film of claim 1, wherein the ethylene-alpha-olefin copolymer comprises from 80 to 97 wt. % of ethylene monomer and from 3 to 20 wt. % of 1-octene or 1-hexene comonomer, based on the total weight of the ethylene-alpha-olefin copolymer.

11. The film of claim 1, wherein the film has a basic weight of from 5 to 60 gsm.

12. The film of claim 1, wherein the film is oriented in the machine direction at a draw ratio of from 3:1 to 9:1, and in the transverse direction at a draw ratio of from 3:1 to 9:1.

13. An article comprising the biaxially-oriented polyethylene film of claim 1.
